(19) United States
(12) Patent Application Publication
(10) Pub. No.: US 2018/0108306 A1
(43) Pub. Date: Apr. 19, 2018

(54) Method For Improving Ghost Image And Liquid Crystal Display Device Using The Same

(71) Applicant: Shenzhen China Star Optoelectronics Technology Co., Ltd., Shenzhen, Guangdong (CN)

(72) Inventors: Wenfang LI, Shenzhen, Guangdong (CN); Xianming ZHANG, Shenzhen, Guangdong (CN)

(73) Assignee: Shenzhen China Star Optoelectronics Technology Co., Ltd., Shenzhen, Guangdong (CN)

(21) Appl. No.: 15/125,959

(22) PCT Filed: Jul. 12, 2016
(86) PCT No.: PCT/CN2016/089738

§ 371 Date: Sep. 13, 2016

(30) Foreign Application Priority Data
May 6, 2016 (CN) 201610298527.6

(51) Int. Cl. G09G 3/36

(52) U.S. Cl. CPC G09G 3/3614; G09G 2320/0673; G09G 2320/0257; G09G 3/3655

(57) ABSTRACT

The present invention provides a method for improving ghost image and a liquid crystal display device using the same, which comprises: providing pixels with data voltage by polarity inversion in frame to frame manner. Wherein when the pixel is written with a positive polarity, a first value is given at a common electrode. and wherein when the pixel is written with a negative polarity, a second value is given with a second value, which is larger than the first value. According to the embodiment of the present invention, a method for improving ghost image and a liquid crystal display device using the same, can prevent or reduce polarization of the liquid crystal and improve ghost image.

### FIELD OF THE INVENTION

The present invention relates to a technology of liquid crystal display, and more particularly, to improve image sticking or ghost image and a liquid crystal display device using the same.

### DESCRIPTION OF PRIOR ART

Liquid crystal display (LCD) has advantages to small size, light weight, high display quality and so on. Images in LCD panel of LCD screen are shown by a plurality of pixels configured in an array. Each pixel is configured by a variety of sub-pixels of different colors. Brightness of each sub-pixel displayed is jointly controlled by the brightness of a backlight module of a LCD, and the grayscale of the sub-pixel of the LCD.

By developing and progressing device technology of LCD, in order to improve display quality of the LCD device, an alternating polarity of voltage driving method of LCD panel has been proposed, i.e., the polarity of voltage is alternatively inverted during a consecutive series of frame to frame so as to display the images normally in a prolonged manner. However, when the driving method is used, polarization of liquid crystal will be occurred and result in ghost image.

### SUMMARY OF THE INVENTION

In order to solve deficiencies of prior art, the present invention provides a method for improving ghost image and a liquid crystal display device using the same.

According to an embodiment in the present invention, on one hand, providing a method for improving ghost image, which comprises: providing pixels with data voltage by polarity inversion in frame to frame manner. Wherein when the pixel is written with a positive polarity, a first value is given at a common electrode. and wherein when the pixel is written with a negative polarity, a second value is given with a second value, which is larger than the first value.

According to the embodiment of the present invention, the common electrode voltage can be determined by the following method: when the pixel is written with the positive polarity, a first controlling signal is generated, and the common electrode voltage with the first value is generated corresponding to the first controlling signal, wherein the first controlling signal is a low-voltage controlling signal; and when the pixel is written with the negative polarity, a second controlling signal is generated, and the common electrode voltage with the second value is generated corresponding to the second controlling signal, wherein the second controlling signal is a high-voltage controlling signal.

According to the embodiment of the present invention, the steps of the common electrode voltage with the first value is generated corresponding to the first controlling signal includes: selecting a code corresponding to the first controlling, which is related to the common electrode voltage with the first value, so as to generate the common electrode voltage with the first value; and the steps of the common electrode voltage with the second value is generated corresponding to the second controlling signal includes: selecting a code corresponding to the second controlling, which is related to the common electrode voltage with the second value, so as to generate the common electrode voltage with the second value.

According to the embodiment of the present invention, the first value can be less than the second value 0.01V-1V.

According to the embodiment of the present invention, the first value can be less than the second value 0.01V.

According to an embodiment in the present invention, on the other hand, providing a liquid crystal display device, which comprises a display panel. The display panel comprises data lines, gate lines and pixels. The pixels are arranged by providing pixels with data voltage by polarity inversion in frame to frame manner. Wherein when the pixel is written with a positive polarity, a first value is given at a common electrode; and wherein when the pixel is written with a negative polarity, a second value is given with a second value, which is larger than the first value.

According to the embodiment of the present invention, the liquid crystal display device further comprises: a controller. When the pixel is written with the positive polarity, a first controlling signal is generated, and when the pixel is written with the negative polarity, a second controlling signal is generated. Wherein the first controlling signal is a low-voltage controlling signal and the second controlling signal is a high-voltage controlling signal. The liquid crystal display device further comprises: a GAMMA IC (integrated circuit). The common electrode voltage with the first value is generated corresponding to the first controlling signal, and the common electrode voltage with the second value is generated corresponding to the second controlling signal.

According to the embodiment of the present invention, the GAMMA IC can comprise a first memory and a second memory. The first memory stores the first code and the second memory stores the second code. The first code corresponding to the common electrode voltage with the first value and the second code corresponding to the common electrode voltage with the second value.

According to the embodiment of the present invention, the GAMMA IC further comprises a bank selection terminal. Wherein when the bank selection terminal received the first controlling signal, selecting the first memory to generate the common electrode voltage with the first value. Wherein when the bank selection terminal received the second controlling signal, selecting the second memory to generate the common electrode voltage with the second value.

According to the embodiment of the present invention, the first value can be less than the second value 0.01V-1V.

According to the embodiment of the present invention, the first value can be less than the second value 0.01V.

According to the embodiment of the present invention, a method for improving ghost image and a liquid crystal display device using the same, can prevent or reduce polarization of the liquid crystal and improve ghost image.

The other aspect and/or advantages of the present invention will be described here below. Other aspect and advantages are obvious, and can be readily understood through the preferred embodiment of the present invention.

### BRIEF DESCRIPTION OF DRAWINGS

Technical implementation will be described below clearly and fully by combining with drawings made in accordance with an embodiment in the present invention.

FIG. 1 is an illustrational view of a driving method of a traditional LCD device;

FIG. 2 is an illustrational view of the method for improving ghost image in accordance to the embodiment of the present invention;

FIG. 3 is an illustrational view of a liquid crystal display device in accordance to the embodiment of the present invention; and

FIG. 4 is an illustrational view showing the changing of the polarity of the voltage with respect each of the frame in the common electrode of the method for improving ghost image in accordance to the embodiment of the present invention.

### DESCRIPTION OF PREFERRED EMBODIMENT

Preferred embodiments of the present invention will be detailedly described here below. It should be noted that the variations of different embodiments should not be construed as the limitation of those embodiments of the present invention. To the contrary, by the detailed description of those embodiments, the present invention can be completely and thoroughly understood to the skilled in the arts. It should be noted that the dimensions, sizes of curtain portions, areas, layers have modified or exaggerated for better understanding. Numeral reference through different drawings represents the same element.

It should be noted that even that first and second are used to described different elements, however, those elements should not be limited by those terms used in describing them. These terms are merely used to distinguish one from another. For example, without departing the scope of the preferred embodiment, the first element can be described as the second elements, and vice versa.

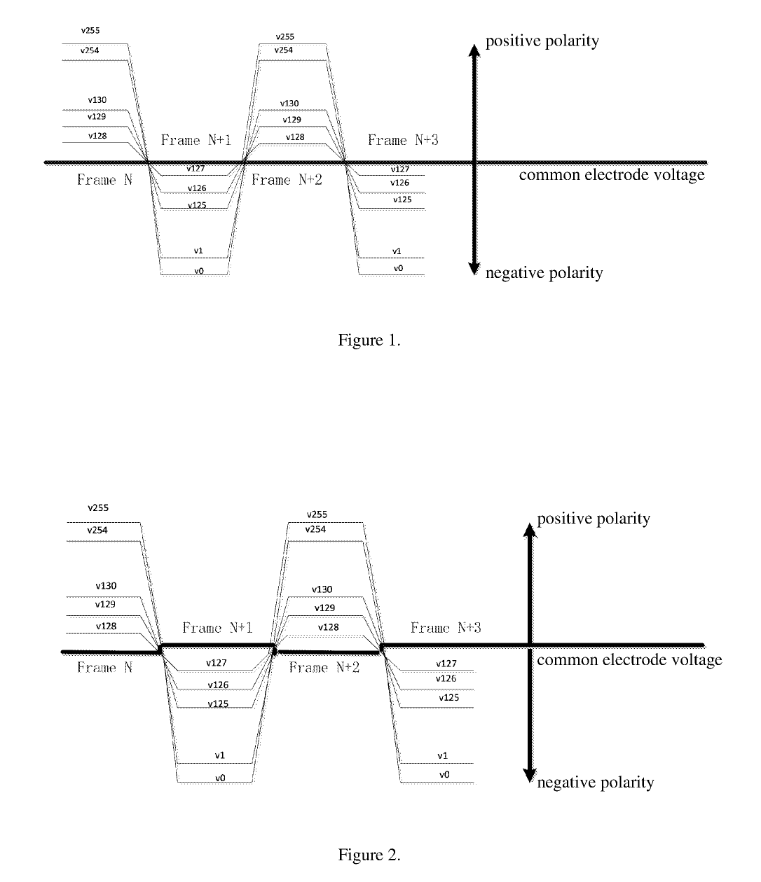

FIG. 1 is an illustrational view of a driving method of a traditional LCD device.

Referring to FIG. 1, in the traditional LCD device, a driving method of a constant common electrode voltage and alternating polarity of voltage in cycle of some frames (e.g., one frame) may be used. For example, Frame N in the N-th frame, a pixel may be written with a positive polarity. Frame N+1 in the N+1-th frame, the pixel may be written with a negative polarity. Frame N+2 in the N+2-th frame, the pixel may be written with a positive polarity. Frame N+3 in the N+3-th frame, the pixel may be written with a negative polarity, and so on, and the common electrode voltage remains constant. Here, N can be an integer larger than 1. Flipping of the liquid crystal depends on the difference between gamma voltage(i.e., V0, V1, . . . , V255) and the common electrode voltage. In theory, the common electrode voltage is the average of V0 and V 255, but the common electrode voltage is smaller than the average of V0 and V255 due to the coupling effect of the capacitor. In addition, positive polarity of voltage and negative polarity of voltage are actually not completely symmetrical, absolute value of the positive polarity is usually larger than absolute value of the negative polarity slightly. So after a long time, because of slightly larger positive polarity of voltage, polarization of liquid crystal will be occurred and result in ghost image.

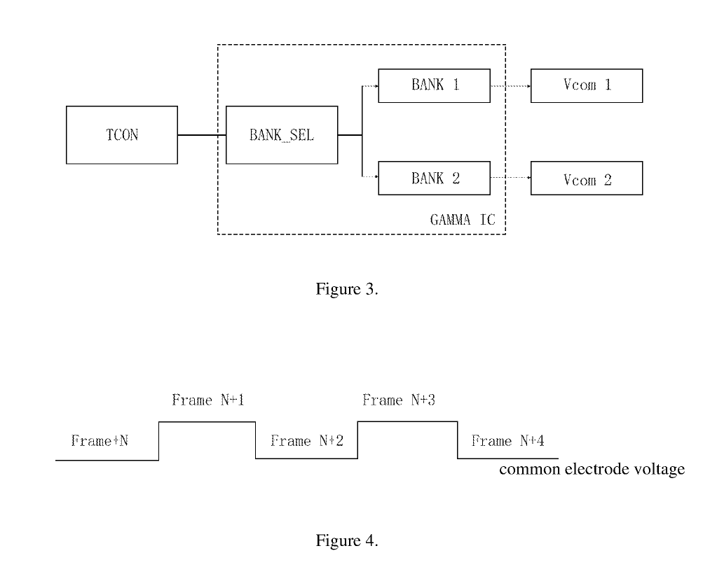

FIG. 2 is an illustrational view of the method for improving ghost image in accordance to the embodiment of the present invention. FIG. 3 is an illustrational view of a liquid crystal display device in accordance to the embodiment of the present invention. FIG. 4 is an illustrational view showing the changing of the polarity of the voltage with respect each of the frame in the common electrode of the method for improving ghost image in accordance to the embodiment of the present invention.

According to the embodiment in the present invention, on one hand, providing a method for improving ghost image, which comprises: providing pixels with data voltage by polarity inversion in frame to frame manner. Wherein when the pixel is written with a positive polarity, a first value is given at a common electrode, and wherein when the pixel is written with a negative polarity, a second value is given with a second value, which is larger than the first value. As shown in FIG. 2, Frame N in the N-th frame, a pixel may be written with a positive polarity, and the common electrode voltage may be a relatively small value of the first value. Frame N+1 in the N+1-th frame, the pixel may be written with a negative polarity, and the common electrode voltage may be a relatively larger value of the second value. Frame N+2 in the N+2-th frame, the pixel may be written with a positive polarity, and the common electrode voltage may be a relatively small value of the first value. Frame N+3 in the N+3-th frame, the pixel may be written with a negative polarity, and the common electrode voltage may be a relatively larger value of the second value, and so on. Here, N can be an integer larger than 1. By changing the value of the common electrode voltage, which can be minor changes in each frame, a larger positive polarity in the forward frame and a larger negative polarity in the next frame of driving voltage can be wholly satisfied, so the positive polarity and the negative polarity can be canceled each other out, the problem of the large positive polarity in traditional LCD device can be avoided. Thereby, polarization of the liquid crystal can be prevented or reduced, improve ghost image and ensure a high display quality. Here, the pixel is written with a positive polarity, it means that a positive polarity pixel voltage is written into a pixel; and the pixel is written with a negative polarity, it means that a negative polarity pixel voltage is written into a pixel. Wherein the pixel voltage is the difference between a data voltage provided to a pixel and a common electrode voltage. When the data voltage is large than the common electrode voltage, the difference between the data voltage and the common electrode voltage is a positive polarity pixel voltage, and when the data voltage is less than the common electrode voltage, the difference between the data voltage and the common electrode voltage is a negative polarity pixel voltage.

According to the embodiment in the present invention, the common electrode voltage can be determined by the following method: when the pixel is written with the positive polarity, a first controlling signal is generated, and the common electrode voltage Vcom 1 with the first value is generated corresponding to the first controlling signal, wherein the first controlling signal is a low-voltage controlling signal; and when the pixel is written with the negative polarity, a second controlling signal is generated, and the common electrode voltage Vcom 2 with the second value is generated corresponding to the second controlling signal, wherein the second controlling signal is a high-voltage controlling signal.

As shown in FIG. 3, the controller TCON can output the controlling signal corresponding to the value changing in each frame to the GAMMA IC. The GAMMA IC can generate the common electrode voltage corresponding to the controlling signal. The GAMMA can store the first code in the first memory BANK 1 and store the second code in the second memory BANK 2. The first code corresponding to the common electrode voltage Vcom 1 with the first value and the second code corresponding to the common electrode voltage Vcom 2 with the second value.

Alternatively, Vcom 1 can be less than Vcom 2 0.01V-1V. Alternatively, Vcom 1 can be less than Vcom 2 0.02V-0.5V. Preferably, Vcom 1 can be less than Vcom 2 0.1V.

According to the embodiment of the present invention, the steps of the common electrode voltage Vcom 1 with the first value is generated corresponding to the first controlling signal includes: selecting a code corresponding to the first controlling, which is related to the common electrode voltage Vcom 1 with the first value, so as to generate the common electrode voltage Vcom 1 with the first value; and the steps of the common electrode voltage Vcom 2 with the second value is generated corresponding to the second controlling signal includes: selecting a code corresponding to the second controlling, which is related to the common electrode voltage Vcom 2 with the second value, so as to generate the common electrode voltage Vcom 2 with the second value.

According to the embodiment of the present invention, the controller TCON can output the controlling signal corresponding to the value changing in each frame to the GAMMA IC. The GAMMA IC can generate the common electrode voltage corresponding to the controlling signal. When the bank selection terminal BANK_SEL (i.e., bank selection pins) in the GAMMA IC received the first controlling signal, selecting the first memory BANK 1 to generate the common electrode voltage Vcom 1 with the first value; and when the bank selection terminal BANK_SEL received the second controlling signal, selecting the second memory BANK 2 to generate the common electrode voltage Vcom 2 with the second value.

As shown in FIG. 4, by changing the value of the common electrode voltage, which can be minor changes in each frame. The difference between the selected gamma voltage (e.g., data voltage) and the common electrode voltage can be satisfied, so the positive polarity and the negative polarity can be canceled each other out. Thereby, polarization of the liquid crystal can be prevented or reduced, and improve image sticking or ghost image.

According to the embodiment in the present invention, providing a liquid crystal display device, which comprises a display panel; the display panel comprising data lines, gate lines and pixels. Wherein when the pixel is written with a positive polarity, a first value is given at a common electrode, and wherein when the pixel is written with a negative polarity, a second value is given with a second value, which is larger than the first value. As shown in FIG. 2, Frame N in the N-th frame, a pixel may be written with a positive polarity, and the common electrode voltage may be a relatively small value of the first value. Frame N+1 in the N+1-th frame, the pixel may be written with a negative polarity, and the common electrode voltage may be a relatively larger value of the second value. Frame N+2 in the N+2-th frame, the pixel may be written with a positive polarity, and the common electrode voltage may be a relatively small value of the first value. Frame N+3 in the N+3-th frame, the pixel may be written with a negative polarity, and the common electrode voltage may be a relatively larger value of the second value, and so on. Here, N can be an integer larger than 1.

As shown in FIG. 3, the liquid crystal display device further comprises: a controller TCON. When the pixel is written with the positive polarity, a first controlling signal is generated, and when the pixel is written with the negative polarity, a second controlling signal is generated. Wherein the first controlling signal is a low-voltage controlling signal and the second controlling signal is a high-voltage controlling signal. The liquid crystal display device further comprises: a GAMMA IC. The common electrode voltage Vcom 1 with the first value is generated corresponding to the first controlling signal, and the common electrode voltage Vcom 2 with the second value is generated corresponding to the second controlling signal.

The GAMMA IC can comprise a first memory BANK 1 and a second memory BANK 2. The first memory BANK 1 can store the first code and the second memory BANK 2 can store the second code. The first code corresponding to the common electrode voltage Vcom 1 with the first value and the second code corresponding to the common electrode voltage Vcom 2 with the second value.

According to the embodiment in the present invention, the GAMMA IC can further comprise a bank selection terminal BANK_SEL (i.e., bank selection pins.) When the bank selection terminal BANK_SEL in the GAMMA IC received the first controlling signal, selecting the first memory BANK 1 to generate the common electrode voltage Vcom 1 with the first value; and when the bank selection terminal BANK_SEL received the second controlling signal, selecting the second memory BANK 2 to generate the common electrode voltage Vcom 2 with the second value.

Alternatively, Vcom 1 can be less than Vcom 2 0.01V-1V. Alternatively, Vcom 1 can be less than Vcom 2 0.02V-0.5V. Preferably, Vcom 1 can be less than Vcom 2 0.1V.

More specifically, according to the embodiment in the present invention, the GAMMA IC can generate common electrode voltage, and which is digitally adjustable. The GAMMA IC can store different codes in the first memory BANK 1 and the second memory BANK 2 respectively, i.e., the first memory BANK 1 can store the first code and the second memory BANK 2 can store the second code. Two different common electrode voltages can be set in by two different codes. The first code corresponding to the common electrode voltage Vcom 1 with the first value and the second code corresponding to the common electrode voltage Vcom 2 with the second value. Wherein Vcom 1 can be less than Vcom 2 0.01V-1V. Preferably, Vcom 1 can be less than Vcom 2 0.1V. When the pixel has a positive polarity, the controller TCON outputs the first controlling signal to the bank selection terminal BANK_SEL in the gamma GAMMA IC, and when the pixel has a negative polarity, the controller TCON outputs the second controlling signal to the bank selection terminal BANK_SEL in the gamma GAMMA IC. When the bank selection terminal BANK_SEL received the first controlling signal with low-voltage, selecting the first memory BANK 1 to generate the common electrode voltage Vcom 1 with the first value; and when the bank selection terminal BANK_SEL received the second controlling signal with high-voltage, selecting the second memory BANK 2 to generate the common electrode voltage Vcom 2 with the second value. Thereby the common electrode voltage can vary between Vcom 1 and Vcom 2 in each frame.

As shown in FIG. 4, by changing the value of the common electrode voltage, which can be minor changes in each frame. The difference between the selected gamma voltage (e.g., data voltage) and the common electrode voltage can be satisfied, so the positive polarity and the negative polarity can be canceled each other out. Thereby, polarization of the liquid crystal can be prevented or reduced, and improve image sticking or ghost image.

According to the embodiment in the present invention, by changing the value of the common electrode voltage, which can be minor changes in each frame, a larger positive polarity in the forward frame and a larger negative polarity in the next frame of driving voltage can be wholly satisfied, so the positive polarity and the negative polarity can be canceled each other out, the problem of the large positive polarity in traditional LCD device can be avoided. Thereby, polarization of the liquid crystal can be prevented or reduced, and improve ghost image effectively.

In addition, according to the above method in the present invention, it can be achieved in computer codes of computer-readable medium. Skilled in the art can achieve the machine language according to the above method. The above method in the present invention is achieved in running the computer codes in computer.

In addition, according to the embodiment in the present invention, each unit of driving device in the liquid crystal panel can be achieved in hardware units. Skilled in the art can use FPGA (field programmable gate array) or ASIC (application specific integrated circuit)to achieve each unit according to processing respectively.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A method for improving ghost image, wherein the method comprises: providing pixels with data voltage by polarity inversion in frame to frame manner; wherein when the pixel is written with a positive polarity, a first value is given at a common electrode; and wherein when the pixel is written with a negative polarity, a second value is given with a second value, which is larger than the first value.

2. The method as recited in claim 1, wherein the common electrode voltage is determined by the following method:
wherein the pixel is written with the positive polarity, a first controlling signal is generated, and the common electrode voltage with the first value is generated corresponding to the first controlling signal, wherein the first controlling signal is a low-voltage controlling signal;
wherein the pixel is written with the negative polarity, a second controlling signal is generated, and the common electrode voltage with the second value is generated corresponding to the second controlling signal, wherein the second controlling signal is a high-voltage controlling signal.

3. The method as recited in claim 2, wherein,
the steps of the common electrode voltage with the first value is generated corresponding to the first controlling signal includes: selecting a code corresponding to the first controlling, which is related to the common electrode voltage with the first value, so as to generate the common electrode voltage with the first value; and
wherein, the steps of the common electrode voltage with the second value is generated corresponding to the second controlling signal includes: selecting a code corresponding to the second controlling, which is related to the common electrode voltage with the second value, so as to generate the common electrode voltage with the second value.

4. The method as recited in claim 1, wherein, the first value is less than the second value 0.01V-1V.

5. The method as recited in claim 1, wherein, the first value is less than the second value 0.01V.

6. A liquid crystal display device, wherein comprises a display panel; the display panel comprising data lines, gate lines and pixels; the pixels be arranged by providing pixels with data voltage by polarity inversion in frame to frame manner; wherein when the pixel is written with a positive polarity, a first value is given at a common electrode; and wherein when the pixel is written with a negative polarity, a second value is given with a second value, which is larger than the first value.

7. The liquid crystal display device as recited in claim 6, wherein further comprises:
a controller; when the pixel is written with the positive polarity, a first controlling signal is generated, and when the pixel is written with the negative polarity, a second controlling signal is generated; wherein the first controlling signal is a low-voltage controlling signal and the second controlling signal is a high-voltage controlling signal; and
a GAMMA IC (integrated circuit);the common electrode voltage with the first value is generated corresponding to the first controlling signal, and the common electrode voltage with the second value is generated corresponding to the second controlling signal.

8. The liquid crystal display device as recited in claim 7, wherein the GAMMA IC comprises a first memory and a second memory; the first memory storing the first code and the second memory storing the second code; the first code corresponding to the common electrode voltage with the first value and the second code corresponding to the common electrode voltage with the second value.

9. The liquid crystal display device as recited in claim 8, wherein the GAMMA IC further comprises a bank selection terminal; wherein when the bank selection terminal received the first controlling signal, selecting the first memory to generate the common electrode voltage with the first value; wherein when the bank selection terminal received the second controlling signal, selecting the second memory to generate the common electrode voltage with the second value.

10. The liquid crystal display device as recited in claim 6, wherein the first value is less than the second value 0.01V-1V.
